(19) United States
(12) Patent Application Publication
(10) Pub. No.: US 2017/0288870 A1
(43) Pub. Date: Oct. 5, 2017

(54) METHODS AND SYSTEMS OF SECURING AND RETRIEVING SECRET INFORMATION

(71) Applicant: Google Inc., Mountain View, CA (US)

(72) Inventors: Bartosz Przydatek, Zurich (CH); Lorenzo Martignoni, Zurich (CH); Christophe De Cannière, Zurich (CH)

(21) Appl. No.: 15/090,923

(22) Filed: Apr. 5, 2016

(51) Int. Cl. H04L 9/08; H04L 29/06

(52) U.S. Cl. CPC H04L 9/0897; H04L 9/085; H04L 63/0492

(57) ABSTRACT

A method of protecting a secret may include, by a client electronic device, identifying a secret, identifying a unique identifier associated with the secret, splitting the secret into shares so that the secret can only be reconstructed with an authorized subset of shares, identifying a share from the plurality of shares to store, and identifying a unique identifier associated with the identified share. A short range communication receiver of the client electronic device may detect a presence of a target electronic device, where the target electronic device is operating in a discoverable mode by using a short range communication transmitter to broadcast a signal within a communication range of the short range communication receiver. The short range communication transmitter of the client electronic device may transmit the identified share, the unique identifier associated with the secret, and the unique identifier associated with the identified share to the target electronic device.

### BACKGROUND

Many approaches to securing data in the cloud are based on client-side encryption, where the secret keys that enable data decryption are never disclosed to the cloud provider. While these solutions address the privacy concerns and limit the potential data exposure, they introduce a new problem, namely total loss of data if the secret encryption key is lost. If the cloud provider doesn't have the secret key and has no access to decrypted data, then by design the provider cannot help to recover the plaintext data.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of protecting a secret may include, by a client electronic device, identifying a secret, identifying a unique identifier associated with the secret, splitting the secret into a plurality of shares so that the secret can only be reconstructed with an authorized subset of shares, identifying a share from the plurality of shares to store, and identifying a unique identifier associated with the identified share. A short range communication receiver of the client electronic device may detect a presence of a target electronic device, where the target electronic device is operating in a discoverable mode by using a short range communication transmitter to broadcast a signal within a communication range of the short range communication receiver. The short range communication transmitter of the client electronic device may transmit the identified share, the unique identifier associated with the secret, and the unique identifier associated with the identified share to the target electronic device.

In an embodiment, the identified share may be retrieved from the target electronic device by transmitting, by the short range communication transmitter of the client electronic device, an indication of the identified share within a communication range of the target electronic device, where the indication includes the unique identifier associated with the secret and the unique identifier associated with the identified share. The short range communication receiver may receive the identified share from the target electronic device.

In an embodiment, the short range communication receiver may receive the indication and the unique identifier associated with the secret and the unique identifier associated with the identified share from the indication may be obtained. It may be determined whether the unique identifier associated with the secret and the unique identifier associated with the identified share correspond to a stored share that is being stored by the target electronic device, and in response to determining that the unique identifier associated with the secret and the unique identifier associated with the identified share correspond to a stored share, transmitting, by a short range communication transmitter of the target electronic device, the stored share to the client electronic device.

In an embodiment, a second share may be identified from the plurality of share, and the client electronic device may cause a print device that is in communication with the client electronic device to print a representation of the second share in an encoded format on a physical substrate. The client electronic device may retrieve the second share by performing image processing of the physical substrate to obtain an image of the second share, and use the second share to reconstruct the secret.

In an embodiment, a method of protecting a secret may include identifying a secret by the client electronic device, splitting the secret into a plurality of shares so that the secret can only be reconstructed with an authorized subset of shares, identifying a unique identifier associated with the secret, identifying, from a data store of the client electronic device, a telephone number associated with the client electronic device, identifying a first share, a second share and a third share from the plurality of shares, and generating a unique identifier associated with each of the first share, the second share and the third share. The method may include transmitting the first share, the unique identifier for the secret, the unique identifier for the first share and the telephone number to a short message service (SMS)-share electronic device in communication with the client electronic device such that the identified share is stored by the SMS-share electronic device in association with the unique identifier associated with the secret, the unique identifier associated with the identified share, and the telephone number. The client electronic device may cause a print device that is in communication with the client electronic device to print a representation of the second share in an encoded format on a physical substrate. A short range communication receiver of the client electronic device may detect a presence of a target electronic device, where the target electronic device is operating in a discoverable mode by using a short range communication transmitter to broadcast a signal within a communication range of the short range communication receiver. The short range communication transmitter of the client electronic device may transmit the third share, the unique identifier associated with the secret, and the unique identified associated with the third share to the target electronic device.

### BRIEF DESCRIPTION OF THE DRAWINGS

FIG. 1 illustrates an example system for securing data according to an embodiment.

FIG. 2 illustrates a flow chart of an example method of protecting a secret according to an embodiment.

FIG. 3 illustrates a flow chart of an example method of causing a share to be stored by an SMS-share electronic device according to an embodiment.

FIG. 4 illustrates a flow chart of an example method of retrieving a share that has been stored on a tangible medium according to an embodiment.

FIG. 5 illustrates a flow chart of an example method of retrieving, by a client electronic device, a share that is being stored by a third-party electronic device according to an embodiment.

FIG. 6 illustrates a flow chart of an example method of retrieving, by a client electronic device, a share that is being stored by an SMS-share electronic device according to an embodiment.

FIG. 7 illustrates a block diagram of example hardware that may be used to contain or implement program instructions according to an embodiment.

### DETAILED DESCRIPTION

The following terms shall have, for purposes of this application, the respective meanings set forth below:

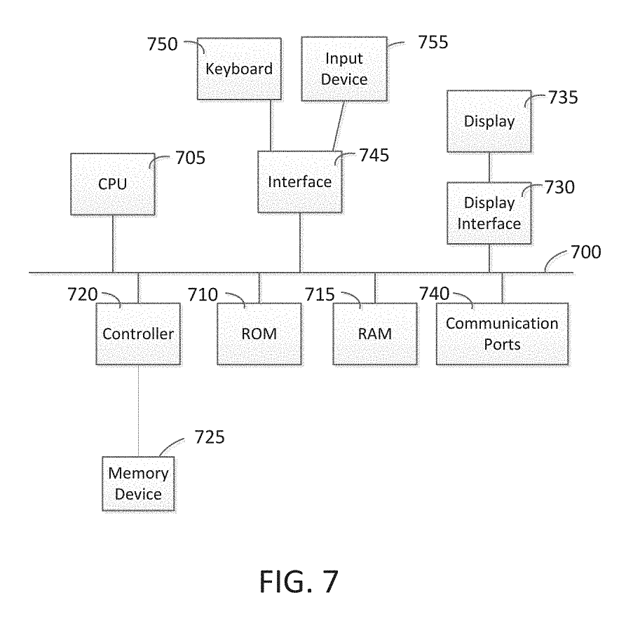

A “computing device” or “electronic device” refers to a device that includes a processor and non-transitory, computer-readable memory. The memory may contain programming instructions that, when executed by the processor, cause the computing device to perform one or more operations according to the programming instructions. As used in this description, a “computing device” or “electronic device” may be a single device, or any number of devices having one or more processors that communicate with each other and share data and/or instructions. Examples of computing devices or electronic devices include, without limitation, personal computers, servers, mainframes, gaming systems, televisions, and portable electronic devices such as smartphones, personal digital assistants, cameras, tablet computers, laptop computers, media players, wearable devices and the like. Various elements of an example of a computing device or processor are described below in reference to FIG. 7.

The terms “memory,” “computer-readable medium” and “data store” each refer to a non-transitory device on which computer-readable data, programming instructions or both are stored. Unless the context specifically states that a single device is required or that multiple devices are required, the terms “memory,” “computer-readable medium” and “data store” include both the singular and plural embodiments, as well as portions of such devices such as memory sectors.

A “print device” refers to a device that is capable of generating or modifying a physical substrate from a digital file. Examples of print devices include, without limitation, inkjet and laser printers, copiers, multifunction devices, 3-D printers, devices that etch or engrave patterns in metal, plastic or other materials, and/or the like.

A “secret” refers to data that is to be protected and shared only with authorized parties. For instance, a secret may be information known only to parties of a communication so that any party's possession of the data or a portion of the data can be used to authenticate a party's identity. Examples of secrets may include, without limitation, private encryption keys, private signing keys, bitcoin keys, passwords, biometrics, and/or the like.

A “user account” refers to an account of a user with a provider, such as a service provider, through which the user can access or is provided with access to software, services and/or the like. A user account may be accessed via one or more authentication credentials such as a login, a password, a biometric, a security token and/or the like.

In various embodiments, a user may have a user account with one or more providers. A user may use a user account to access software, services and/or the like of the provider. Example user accounts may include, without limitation, an email account, a social media account, a cloud services account, an account with a retailer, an account for the provision of media such as music, videos and/or the like, a financial institution account and/or the like.

A user's data that is stored by a provider may be encrypted so that only the user can decrypted it using a secret on the user's client electronic device. A client electronic device refers to an electronic device associated with a user, such as, for example, a smartphone, a tablet, a desktop computer and/or the like.

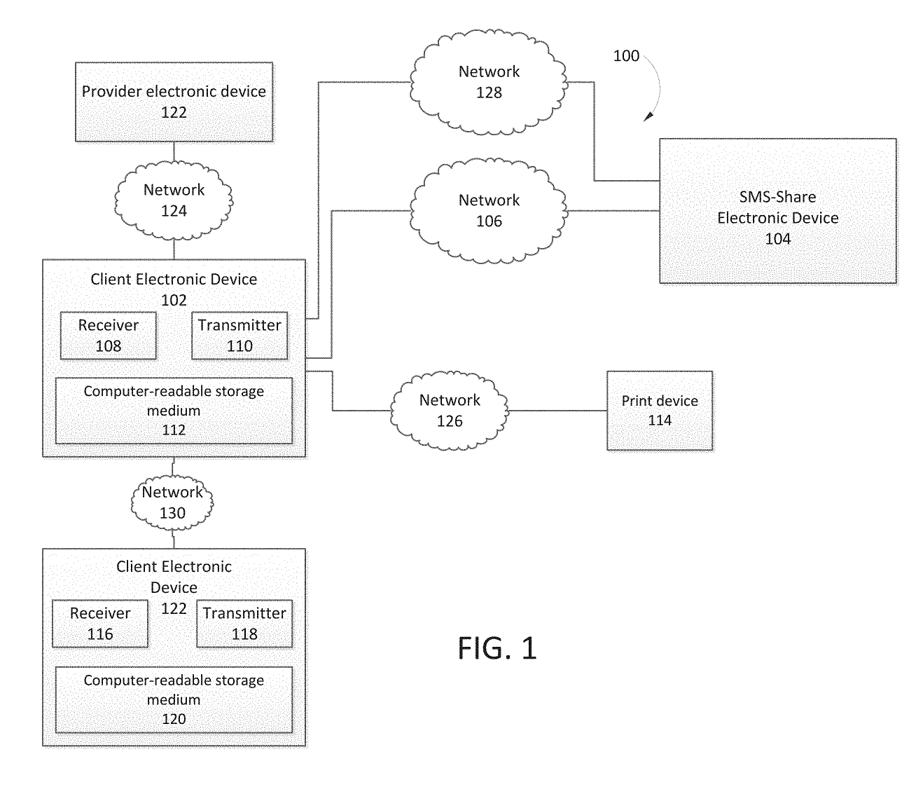

FIG. 1 illustrates an example system for securing data according to an embodiment. As illustrated by FIG. 1, the system 100 may include a client electronic device 102 in communication with an SMS-share electronic device 104, a printing device 114, a provider electronic device 122 and/or another client electronic device 122 via one or more communication networks 106, 124, 126, 128, 130.

In an embodiment, a provider electronic device 122 may be an electronic device associated with a service provider, such as, for example, a document backup service, an email provider and/or the like. A service provider may provide a cloud-based service, or another type of service. Examples of a provider electronic device may include without limitation, a laptop computer, a desktop computer, a tablet, a mobile device, a server, a mainframe or other computing or electronic device. A communication network 106, 124, 126, 128, 130 may be a local area network (LAN), a wide area network (WAN), a mobile or cellular communication network, an extranet, an intranet, the Internet, a short range communication network and/or the like. Although FIG. 1 shows separate communication networks 106, 124, 126, 128, 130 it is to be understood that these networks, or some combination of these networks, may be implemented as a single communication network.

In various embodiments, a client electronic device 102 may communicate with an SMS-share electronic device 104, and vice versa, via one or more short message service (SMS) messages. For instance, an SMS-share electronic device 104 may be associated with one or more short message service centers (SMSC), which may send and/or receive SMS messages. An SMSC may communicate with the Pubic Land Mobile Network (PLMN) or public switch telephone network (PSTN) via one or more gateways, such as a mobile switching center, an email-to-SMS gateway and/or the like. In an embodiment, as illustrated by FIG. 1, a client electronic device 102 and an SMS-share electronic device 104 may send and/or receive SMS messages to the other via a communication network 128. A client electronic device 102 and an SMS-share electronic device 104 may also communicate with one another over a separate communication network 106.

As illustrated by FIG. 1, a client electronic device 102 may be in communication with one or more other client electronic devices 122 via one or more communication networks 130. Although FIG. 1 shows two client electronic devices 102, 122 in communication, it is understood that additional and/or alternate client electronic devices may be used within the scope of this disclosure. In an embodiment, a client electronic device 102 may communicate with or more other client electronic devices 122 that are associated with the same user. For instance, a user may have a tablet and a smartphone which may communicate with one another. In another embodiment, a client electronic device 102 may communicate with one or more client electronic devices 122 that are associated with a different user. For instance, a smartphone of a user may communicate with a tablet belonging to the user's husband. Additional and/or alternate communications may be used within the scope of this disclosure.

In various embodiments, a client electronic device 102 may communicate with one or more other client electronic devices 122 via short range communication such as, for example, near field communication (NFC), radio frequency identification (RFID), Bluetooth and/or the like. One or more client electronic devices 102, 122 may include a short range communication receiver 108, 116, and/or transmitter 110, 118 such as, an RFID tag, a Bluetooth antenna, an NFC chip and/or the like.

In certain embodiments, a client electronic device 102 may communicate with one or more other client electronic devices 122 via a communication network 130, which may be an authenticated and secure communication channel.

In an embodiment, a client electronic device 102 may be in communication with a print device 114 via a communication network 126. A print device 114 may be a standalone device, or a print device may be incorporated into a client electronic device.

In certain embodiments, one or more client electronic devices 102, 122 may include a microphone and/or one or more speakers. A client electronic device 102, 122 may be configured to detect and respond to auditory or spoken commands. For instance, a client electronic device 102, 122 may have a microphone that may capture one or more spoken commands of a user, and may translate the spoken commands into one or more actions.

In various embodiments, a client electronic device 102, 122 may store one or more instructions in one or more computer-readable storage media 112, 120. The instructions, when executed, may cause a client electronic device 102, 122 to protect a secret in a manner consistent with this disclosure. The one or more instructions may be implemented as an application that resides on a client electronic device 102, 122. The application may be accessible by a user of a client electronic device 102, 122, and a user may receive information from or provide information to the application via a user interface of the client electronic device 102, 122. For instance, a user may provide information to an application via a touch screen interface of a client electronic device 102, 122, a keyboard of a client electronic device, voice commands, or other input techniques. Similarly, a client electronic device 102, 122 may display information to a user via a displace device such as, for instance, a screen, a touch screen or a monitor.

In various embodiments, one or more instructions stored by a client electronic device may not require a user to have an account or any authentication credentials in order to store one or more secrets. As such, the instructions, when executed, may cause a client electronic device to store one or more secrets without requiring a user to maintain an account, credentials or other access restrictions. In addition, the instructions may cause a client electronic device to store one or more secrets corresponding to one or more user accounts, which may or may not be associated with the same provider. For instance, the instructions may cause a client electronic device to store a secret associated with a user's user account with a first provider as well as a secret associated with the user's user account with a second (and different) provider. As such, the instructions may cause a client electronic device to store one or more secrets across one or more different user accounts, providers, services and/or the like.

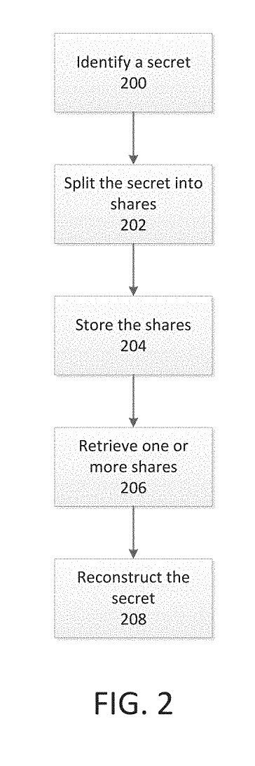

FIG. 2 illustrates a flow chart of an example method of protecting a secret according to an embodiment. As illustrated, a client electronic device may identify 200 a secret to be protected. In an embodiment, a secret may be stored on a client electronic device. For instance, a client electronic device may store one or more secret keys associated with one or more user accounts. A client electronic device may identify 200 a secret by retrieving the secret from memory.

In various embodiments, metadata may be stored by one or more provider electronic devices. Metadata may be associated with a secret, one or more shares and/or the like. For instance, metadata associated with a secret may describe or identify the secret. But the metadata may not disclose the secret itself. As another example, metadata associated with a share may identify or describe a share. To protect the secret, the secret and the metadata associated with the secret may be stored in different locations. Similarly, a share and metadata associated with the share may be stored in different locations.

In certain embodiments, a client electronic device may identify 200 a secret to be protected in response to the occurrence of certain actions. For instance, a client electronic device may identify 200 a secret in response to a user creating a new user account, changing an authentication credential for an existing user account and/or the like. In other embodiments, a client electronic device may identify 200 a secret to be protected at certain regular or random intervals or time periods.

In an embodiment, a client electronic device may split 202 the secret into a plurality of portions or shares. Each share may be of equal size, or one or more of the shares may have a different size than one or more of the other shares. In certain embodiments, a secret may be split into n shares using a k-out-of-n secret sharing technique. For instance, a secret S may be split such that S→S_1, S_2, . . . , S_n, where any k or more shares (and associated metadata) may allow for reconstruction of S, while any set of up to k−1 shares (even in association with metadata) does not provide any information about S.

In an embodiment, one or more of the shares may be stored 204. A share may be stored in one of three different ways. The manner in which a share is to be stored may be determined by a user. For instance, a client electronic device may prompt a user to indicate how a particular share is to be stored. The client electronic device may then store the share in the manner indicated by the user. In an alternate embodiment, a share may be stored in a manner specified by one or more settings, configurations and/or the like. For instance, a user may provide a client electronic device with one or more instructions as to how a share is to be stored, and the electronic device may automatically store the share in accordance with the instructions without requiring additional user feedback.

In an embodiment, an electronic device may cause a representation of a share to be printed on a tangible medium by a print device, such as, for example, a printer or a multi-function device. In other embodiments, a client electronic device may include a printing device. A representation of a share may be printed in one or more formats such as, for instance, as a Quick Response (QR) code, as a base-64 encoded sequence, or in another encoded format. In various embodiments, a representation of a share may be printed in an optical character recognition (OCR)-friendly font to provide for a more efficient retrieval process as further described below. A user may keep the printed representation in a safe place until it is needed.

In another embodiment, a client electronic device may cause a share to be stored on a different electronic device than the client electronic device. In an embodiment, a client electronic device may transmit a share to a different electronic device via short-range communication such as, for instance, NFC, RFID or Bluetooth. For example, a client electronic device may use a short range communication transmitter to transmit the share. A different electronic device that is in a transmission range of the transmission may detect the transmission and may receive the transmitted share via its short range communication receiver. In another embodiment, a client electronic device may transmit a share to a different electronic device over an authenticated and secure, such as encrypted, communication network. The electronic device that receives the transmitted share may store the share.

In various embodiments, a client electronic device may transmit a share to an electronic device that is associated with the same user as the client electronic device. For instance, a smartphone associated with a user may transmit a share to a tablet associated with the user. As another example, a client electronic device may transmit a share to an electronic device that is not associated with the same user.

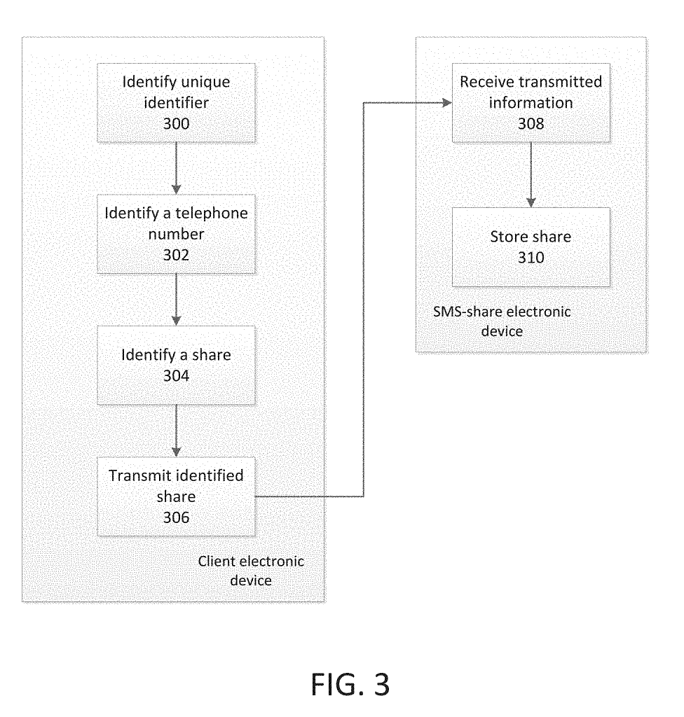

In an embodiment, a client electronic device may cause a share to be stored by an SMS-share electronic device. An SMS-share electronic device may be an electronic device associated with a provider that is configured to send one or more SMS messages to one or more client electronic and/or other electronic devices. An SMS-share electronic device may also store one or more SMS messages, content of one or more SMS messages and/or the like. FIG. 3 illustrates a flow chart of an example method of causing a share to be stored by an SMS-share electronic device according to an embodiment.

In various embodiments, a secret may be associated with a unique identifier. The unique identifier may be assigned to a secret by a client electronic device, one or more provider electronic devices and/or the like. As illustrated by FIG. 3, a client electronic device may identify 300 a unique identifier associated with the secret. A client electronic device may identify 300 a unique identifier associated with a secret by retrieving it from memory, receiving it from a provider electronic device, receiving it from another electronic device, obtaining it from a user and/or the like. In an embodiment, a client electronic device may generate a unique identifier associated with one or more shares.

A client electronic device may identify 302 a telephone number associated with the client electronic device. An associated telephone number may be the telephone number via which a client electronic device, such as a smartphone or other mobile device, may receive and place telephone calls and/or send or receive SMS messages. In an embodiment, a telephone number may be stored in memory by a client electronic device. For instance, a telephone number may be stored on a Subscriber Identity Module (SIM) card, a Secure Digital (SD) card or in an internal storage medium of the client electronic device. In other embodiments, a client electronic device may receive a telephone number from a user. For instance, a client electronic device may prompt a user to provide the telephone number, and may receive this information from a user via a user interface of the client electronic device such as, for example, via a touch screen.

In an embodiment, a client electronic device may identify 304 a share to transmit to an SMS-share electronic device. A client electronic device may identify 304 a share to transmit based on one or more settings. One or more of the settings may be provided by a user. For instance, a user may indicate that a certain share is to be transmitted to an SMS-share electronic device. A client electronic device may identify 304 that a share is to be transmitted to an SMS-share electronic device if the user-identified share has not yet been transmitted to the SMS-share electronic device. In another embodiment, a user may specify on a share-by-share basis whether a particular share is to be transmitted to an SMS-share electronic device. If a client electronic device receives an indication from a user that a particular share is to be provided to an SMS-share electronic device, the client electronic device may identify 304 the share as one to be transmitted to the SMS-share electronic device.

A client electronic device may transmit 306 the identified share, the unique identifier associated with the secret to which the identifier share corresponds, the unique identifier associated with the share and/or the identified telephone number to an SMS-share electronic device via a communications network.

An SMS-share electronic device may receive 308 the transmitted information, and may store the identified share such that it is associated with the received unique identifier associated with the secret, the unique identifier associated with the share and telephone number. For instance, an SMS-share electronic device may store 310 a share in a database, table, list or other data structure so that it is associated with the received unique identifiers and telephone number.

In an embodiment, an SMS-share electronic device may require that a client electronic device that sent a share confirm that the share is to be stored before actually storing the share. For instance, upon receiving a request to store a share, an SMS-share electronic device may generate a confirmation code. In certain embodiments, an SMS-share electronic device may generate a random confirmation code. The SMS-share electronic device may send the confirmation code to the client electronic device from which the request was received. If the SMS-share electronic device does not receive the confirmation code back from the client electronic device within a certain time period, the SMS-share electronic device may not store the received share. If the SMS-share electronic device does receive the confirmation code from the client electronic device within the applicable time period, the SMS-share electronic device may store the share.

Referring back to FIG. 2, a client electronic device may retrieve 206 one or more shares. A client electronic device may retrieve 206 one or more shares in order to recreate or use the secret to which the shares correspond. For instance, a client electronic device may retrieve one or more shares of a secret when a user wants to access a user account to which the secret corresponds. As another example, a client electronic device may retrieve one or more shares of a secret when the secret is needed to access information, decrypt information, perform an action and/or the like.

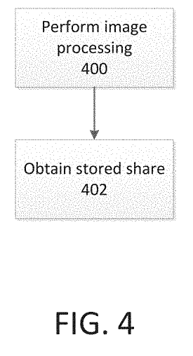

The manner in which a client electronic device retrieves 206 a share may depend on the manner in which the share has been stored. FIG. 4 illustrates a flow chart of an example method of retrieving a share that has been stored on a tangible medium according to an embodiment. As discussed above, a share may be printed on a tangible medium by a print device. To retrieve a share that has been stored in this manner, a client electronic device performs 400 image processing on the tangible medium on which the share is printed. Image processing may include, without limitation, scanning the medium, capturing an image of the medium, performing OCR or performing one or more image processing techniques. In various embodiments, a client electronic device may include a scanner, a camera, a reader or other component to perform image processing. For instance, a client electronic device may include a QR-reader that it may use to perform image processing of a QR-code representation of a share. Similarly, a client electronic device may include a barcode reader that it may use to perform image processing of a barcode representation of a share. In certain embodiments, a client electronic device may process information that it obtains from image processing to obtain 402 the stored share.

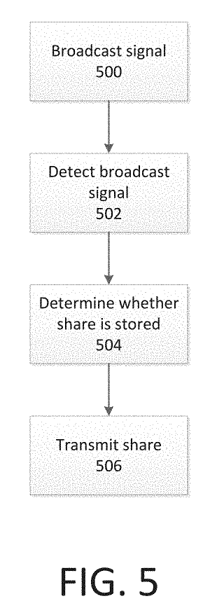

FIG. 5 illustrates a flow chart of an example method of retrieving, by a client electronic device, a share that is being stored by a third-party electronic device according to an embodiment. Although the term “third-party electronic device” is used to differentiate between electronic devices, it is understood that a third-party electronic device may be associated with the same user as the client electronic device.

As illustrated by FIG. 5, a client electronic device that is retrieving a share may broadcast 500 a signal when the client electronic device operates in a discoverable mode. In an embodiment, the signal may include an indication of the share that the client electronic device wishes to retrieve. The indicator may include an identifier associated with a secret to which a share to retrieve corresponds and/or an identifier associated with the share to be retrieved. For instance, an indicator may have a format (share identifier, secret identifier) according to an embodiment. Additional and/or alternate indicators may be used within the scope of this disclosure.

A short range communication receiver of a third-party electronic device on which the share is stored may detect 502 the broadcast signal when it is broadcast within a communication range of the third-party's short range communication receiver. In response to detecting 502 the presence of the client electronic device, a third-party electronic device may determine 504 whether it is storing the share identified by the received signal. For instance, as described above, a broadcast signal may include an indicator identifying the share and/or the secret at issue. A third-party electronic device may use the information included in the indicator to determine whether it is storing a share corresponding to the one requested by the broadcast signal. For example, a third-party electronic device may search a database, memory or other storage media for a share corresponding to the share identifier and the secret identifier included in a broadcast signal.

In response to determining that the third-party electronic device is storing the share identified by the received signal, the third-party electronic device may transmit 506 the share to the client electronic device. In an embodiment, a third-party electronic device may transmit 506 a share to a client electronic device using a short range communication channel such as, for instance, NFC, Bluetooth, RFID and/or the like.

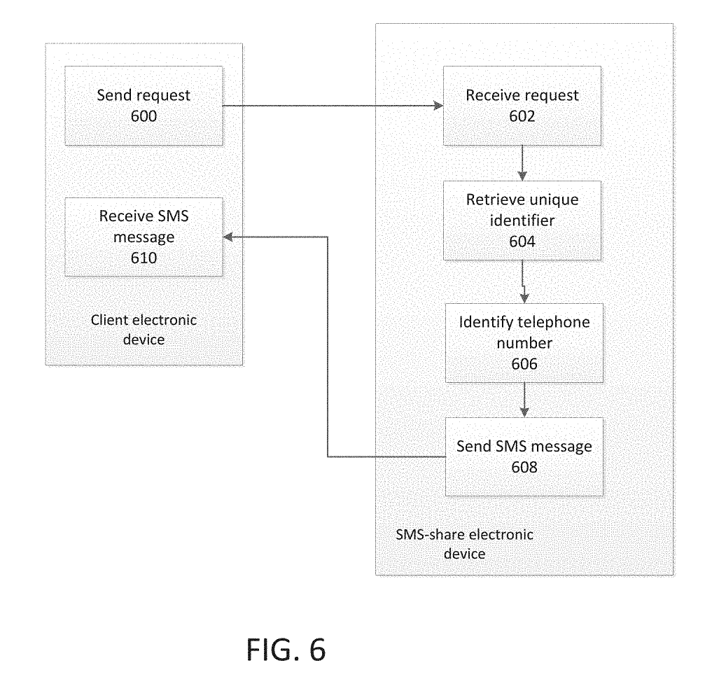

FIG. 6 illustrates a flow chart of an example method of retrieving, by a client electronic device, a share that is being stored by an SMS-share electronic device according to an embodiment. As shown by FIG. 6, a client electronic device may send 600 a request for a certain share or shares to an SMS-share electronic device. The request may include one or more unique identifiers associated with secret to which the share corresponds and/or the share itself.

The SMS-share electronic device may receive 602 the request, and may retrieve 604 the unique identifier(s) from the request. The SMS-share electronic device may identify 606 a telephone number to which a retrieved share should be provided. In an embodiment, an SMS-share electronic device may identify 606 a telephone number by identifying a telephone number that corresponds to the retrieved unique identifier(s) from storage.

In an embodiment, an SMS-share electronic device may only allow a certain number of requests for a particular client electronic device over a certain period of time. An SMS-share electronic device may limit the number of requests in an effort to prevent spamming. For instance, an SMS-share electronic device may only allow one request pertaining to a phone number per day. Additional and/or alternate time periods or restrictions may be used within the scope of this disclosure.

In an embodiment, an SMS-share electronic device may send 608 an SMS message to a client electronic device associated with the identified telephone number, which may receive 610 the SMS message. The SMS message may include one or more shares stored by the SMS-share electronic device to which the unique identifier(s) included in the received request corresponds. In certain embodiments, the SMS-share electronic device may send one share per SMS message. In other embodiments, the SMS-share electronic device may send more than one share per SMS message.

In another embodiment, an SMS-share electronic device may send 608 an SMS message to a client electronic device associated with the identified telephone number that may include a token associated with one or more shares stored by the SMS-share electronic device to which the unique identifier(s) correspond. For example, in certain situations, a share may be too large to transmit via SMS message, so a token may be used instead. A token may be a mechanism that provides a user with indirect access to a requested share. For instance, instead of sending a client electronic device a requested share itself, an SMS-share electronic device may send the client electronic device an SMS message that includes a token for the share. When a token is activated, by a user or otherwise, a client electronic device may gain access to the corresponding share. In some embodiments, a token may be a hyperlink or uniform resource locator (URL). For instance, an SMS message may include a URL. A user may select the URL to fetch the corresponding share.

In an embodiment, a token may only be active for a certain period of time. If the token is not activated within that time period, the token may expire and may not be used to access the corresponding share. For instance, a token may have a life of a few minutes before the token expires. Additional and/or alternate time periods may be used within the scope of this disclosure.

Referring back to FIG. 2, a client electronic device may use the retrieved share to reconstruct 208 the secret. In an embodiment, a client electronic device may reconstruct 208 a secret after retrieving at least an authorized subset of the shares. An authorized subset may include a certain number of shares. For instance, an authorized subset may require a threshold number of shares, for instance, three shares, in order to reconstruct a secret. In another embodiment, an authorized subset of shares may require that certain shares be included in the subset in order to reconstruct a secret. For instance, if a secret is split into five shares—Share A, Share B, Share C, Share D and Share E, the secret may not be reconstructed without Share A and Share E. As such, any subset of the shares that includes Share A and Share E, in addition to any other shares, may be considered an authorized subset regardless of how many other shares are included in the subset. On the other hand, if a subset includes Share A, Share B, Share C, and Share D, but not Share E, then reconstruction of the secret is not possible.

A client electronic device may retrieve one or more shares using one or more of the approaches described in this disclosure until it has retrieved at least an authorized subset of shares needed to reconstruct 208 the secret. Once a client electronic device has reconstructed a secret, the client electronic device may use the secret as directed by a user. For instance, a client electronic device may use the secret to gain access to a user account, decrypt or otherwise access information, spend money, or perform another action.

FIG. 7 depicts a block diagram of an example of internal hardware that may be used to contain or implement program instructions, such as the process steps discussed above, according to embodiments. A bus 700 serves as an information highway interconnecting the other illustrated components of the hardware. CPU 705 represents one or more processors of the system, performing calculations and logic operations required to execute a program. CPU 705, alone or in conjunction with one or more of the other elements disclosed in FIG. 7, is an example of a processing device, computing device or processor as such terms are used within this disclosure. Read only memory (ROM) 710 and random access memory (RAM) 715 constitute examples of memory devices or processor-readable storage media.

A controller 720 interfaces with one or more optional tangible, computer-readable memory devices 725 to the system bus 700. These memory devices 712 may include, for example, an external or internal disk drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 710 and/or the RAM 715. Optionally, the program instructions may be stored on a tangible computer readable medium 725 such as a compact disk, a digital disk, flash memory, a memory card, a USB drive, an optical disc storage medium, such as a Blu-Ray™ disc, and/or other recording medium controlled via a disk controller 720.

An optional display interface 730 may permit information from the bus 700 to be displayed on the display 735 in audio, visual, graphic or alphanumeric format. Communication with external devices, such as a print device, may occur using various communication ports 740. A communication port 740 may be attached to a communications network, such as the Internet or an intranet.

The hardware may also include an interface 745 which allows for receipt of data from input devices such as a keyboard 750 or other input device 755 such as a mouse, a joystick, a touch screen, a remote control, a pointing device, a video input device and/or an audio input device.

It will be appreciated that the various above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of protecting a secret, the method comprising:
by a client electronic device, identifying a secret;
by a client electronic device, identifying a unique identifier associated with the secret;
by the client electronic device, splitting the secret into a plurality of shares so that the secret can only be reconstructed with an authorized subset of shares;
by the client electronic device, identifying a share from the plurality of shares to store;
by the client electronic device, identifying a unique identifier associated with the identified share;
by a short range communication receiver of the client electronic device, detecting a presence of a target electronic device, wherein the target electronic device is operating in a discoverable mode by using a short range communication transmitter to broadcast a signal within a communication range of the short range communication receiver; and
by the short range communication transmitter of the client electronic device, transmitting, the identified share, the unique identifier associated with the secret, and the unique identifier associated with the identified share to the target electronic device.

2. The method of claim 1, further comprising retrieving the identified share from the target electronic device by:
by the short range communication transmitter of the client electronic device, transmitting an indication of the identified share within a communication range of the target electronic device, wherein the indication comprises the unique identifier associated with the secret and the unique identifier associated with the identified share; and
receiving, by the short range communication receiver of the client electronic device, the identified share from the target electronic device.

3. The method of claim 2, further comprising:
receiving, by a short range communication receiver of the target electronic device, the indication;
obtaining the unique identifier associated with the secret and the unique identifier associated with the identified share from the indication;
determining whether the unique identifier associated with the secret and the unique identifier associated with the identified share correspond to a stored share that is being stored by the target electronic device; and
in response to determining that the unique identifier associated with the secret and the unique identifier associated with the identified share correspond to a stored share, transmitting, by a short range communication transmitter of the target electronic device, the stored share to the client electronic device.

4. The method of claim 1, further comprising:
identifying a second share from the plurality of shares; and
by the client electronic device, causing a print device that is in communication with the client electronic device to print a representation of the second share in an encoded format on a physical substrate.

5. The method of claim 4, further comprising:
by the client electronic device, retrieving the second share by performing image processing of the physical substrate to obtain an image of the second share; and
using the second share to reconstruct the secret.

6. A method of protecting a secret, the method comprising:
by a client electronic device, identifying a secret;
by the client electronic device, splitting the secret into a plurality of shares so that the secret can only be reconstructed with an authorized subset of shares;
identifying a unique identifier associated with the secret;
identifying, from a data store of the client electronic device, a telephone number associated with the client electronic device;
identifying a first share, a second share and a third share from the plurality of shares;
generating a unique identifier associated with each of the first share, the second share and the third share;
transmitting the first share, the unique identifier for the secret, the unique identifier for the first share and the telephone number to a short message service (SMS)-share electronic device in communication with the client electronic device such that the identified share is stored by the SMS-share electronic device in association with the unique identifier associated with the secret, the unique identifier associated with the identified share, and the telephone number;
by the client electronic device, causing a print device that is in communication with the client electronic device to print a representation of the second share in an encoded format on a physical substrate;
by a short range communication receiver of the client electronic device, detecting a presence of a target electronic device, wherein the target electronic device is operating in a discoverable mode by using a short range communication transmitter to broadcast a signal within a communication range of the short range communication receiver; and
by the short range communication transmitter of the client electronic device, transmitting, the third share, the unique identifier associated with the secret, and the unique identified associated with the third share to the target electronic device.

7. The method of claim 6, further comprising retrieving the first share by:
by the client electronic device, transmitting a request to retrieve the first share from the SMS-share electronic device, wherein the request comprises the unique identifier associated with the secret and the unique identifier associated with the first share; and
by the client electronic device, receiving an SMS message from the SMS-share electronic device.

8. The method of claim 6, further comprising:
by the client electronic device, retrieving the second share by performing image processing of the physical substrate to obtain an image of the second share; and
using the second share to reconstruct the secret.

9. The method of claim 6, further comprising retrieving the identified share from the target electronic device by:
by the short range communication transmitter of the client electronic device, transmitting an indication of the third share within a communication range of the target electronic device, wherein the indication comprises the unique identifier associated with the secret and the unique identifier associated with the third share; and
receiving, by the short range communication receiver of the client electronic device, the third share from the target electronic device.

10. A system for protecting a secret, the system comprising:
a client electronic device comprising a short range communication receiver;
a computer-readable storage medium comprising one or more programming instructions that, when executed, cause the client electronic device to:
identify a secret,
identify a unique identifier associated with the secret,
split the secret into a plurality of shares so that the secret can only be reconstructed with an authorized subset of shares,
identify a share from the plurality of shares to store,
identify a unique identifier associated with the identified share,
detect, by the short range communication receiver, a presence of a target electronic device, wherein the target electronic device is operating in a discoverable mode by using a short range communication transmitter to broadcast a signal within a communication range of the short range communication receiver, and
transmit, by the short range communication transmitter of the client electronic device, the identified share, the unique identifier associated with the secret, and the unique identifier associated with the identified share to the target electronic device.

11. The system of claim 10, wherein the computer-readable storage medium further comprises one or more programming instructions that, when executed, cause the client electronic device to retrieve the identified share from the target electronic device by:
by the short range communication transmitter of the client electronic device, transmit an indication of the identified share within a communication range of the target electronic device, wherein the indication comprises the unique identifier associated with the secret and the unique identifier associated with the identified share; and
receive, by the short range communication receiver of the client electronic device, the identified share from the target electronic device.

12. The system of claim 11, wherein the computer-readable storage medium further comprises one or more programming instructions that, when executed, cause the client electronic device to:
receive, by a short range communication receiver of the target electronic device, the indication;
obtain the unique identifier associated with the secret and the unique identifier associated with the identified share from the indication;
determine whether the unique identifier associated with the secret and the unique identifier associated with the identified share correspond to a stored share that is being stored by the target electronic device; and
in response to determining that the unique identifier associated with the secret and the unique identifier associated with the identified share correspond to a stored share, transmit, by a short range communication transmitter of the target electronic device, the stored share to the client electronic device.

13. The system of claim 10, wherein the computer-readable storage medium further comprises one or more programming instructions that, when executed, cause the client electronic device to:
identify a second share from the plurality of shares; and
cause a print device that is in communication with the client electronic device to print a representation of the second share in an encoded format on a physical substrate.

14. The system of claim 13, wherein the computer-readable storage medium further comprises one or more programming instructions that, when executed, cause the client electronic device to:
retrieve the second share by performing image processing of the physical substrate to obtain an image of the second share; and
use the second share to reconstruct the secret.
